(19) United States
(12) Patent Application Publication
(10) Pub. No.: US 2018/0283636 A1
(43) Pub. Date: Oct. 4, 2018

(54) ILLUMINATION ARRANGEMENT AND HEADLAMP

(71) Applicant: OSRAM GmbH, Munich (DE)

(72) Inventor: Andre Nauen, Regensburg (DE)

(21) Appl. No.: 15/927,164

(22) Filed: Mar. 21, 2018

(30) Foreign Application Priority Data
Apr. 3, 2017 (DE) 10 2017 205 609.6

(51) Int. Cl. F21S 41/16; F21S 45/10; F21S 41/20; F21S 45/40; F21V 29/70

(52) U.S. Cl. CPC F21S 41/16; F21S 45/10; F21V 29/70; F21S 45/40; F21S 41/20

(57) ABSTRACT

In various embodiments, an illumination arrangement and a headlamp are provided. The illumination arrangement may include a converter apparatus. The converter apparatus may include a converter having an input side for excitation radiation and an output surface for used light. The converter apparatus may further include a heat sink. The input side may be connected to the heat sink via at least one heat sink surface. The input side may have at least one input surface. The at least one input surface may be configured to receive excitation radiation from at least one radiation source at an angle γ with respect to a surface normal to the input surface, such that the excitation radiation from the at least one radiation source is reflected at the output surface.

### CROSS-REFERENCE TO RELATED APPLICATION

This application claims priority to German Patent Application Serial No. 10 2017 205 609.6, which was filed Apr. 3, 2017, and is incorporated herein by reference in its entirety and for all purposes.

### TECHNICAL FIELD

Various embodiments relate generally to an illumination arrangement. Various embodiments furthermore relate generally to a headlamp, e.g. for a vehicle.

### BACKGROUND

LARP (Laser Activated Remote Phosphor) systems are disclosed. In this technology, a conversion element or a converter that is arranged at a distance from a radiation source and has, or consists of, a phosphor is irradiated by excitation radiation, e.g. an excitation beam or pump beam or pump laser beam, e.g. by the excitation beam of a laser diode. The excitation radiation is at least partly absorbed by the phosphor and at least partly converted into conversion radiation or into conversion light, the wavelengths of which and hence the spectral properties and/or color of which are determined by the conversion properties of the phosphor. In the case of down conversion, the excitation radiation of the radiation source is converted by the irradiated phosphor into conversion radiation having longer wavelengths than the excitation radiation. By way of example, this allows the conversion element to convert blue excitation radiation, e.g. blue laser light, into red and/or green and/or yellow conversion radiation. In the case of a partial conversion, white used light is produced, for example, from a superposition of non-converted blue excitation light and yellow conversion light.

In a LARP system, two different converter arrangements are typically utilizable. The converter arrangement can be configured, for example, as a transmissive arrangement or a reflective arrangement. The effect of the reflective variant is the better thermal connection of the converter, because in contrast to the transmissive variant, no optically transparent heat sink, such as a substrate on which the phosphor is then arranged, is necessary. By way of example, it is possible in the reflective variant for the phosphor to be arranged on a metallic mirror, the thermal conductivity of which is significantly increased as compared to the light-transmissive substrate, such as sapphire. An effect of the transmissive variant lies in the configuration of an optical overall system that is simple in terms of apparatus. For example, a first optical unit for guiding the excitation radiation to the phosphor can be provided in the beam path between the laser diode and the phosphor. A further optical unit that images used light emitted by the phosphor can be arranged downstream of the phosphor. In the reflective variant, both optical units or optical subsystems are arranged in the same half space owing to the principles involved, which is complicated in terms of apparatus and can lower system efficiency. In the transmissive variant, on the other hand, the optical units or the optical subsystems can be arranged in a respective half space, i.e. before and after the phosphor. This may result in more generous installation space for the optical units.

### SUMMARY

In various embodiments, an illumination arrangement and a headlamp are provided. The illumination arrangement may include a converter apparatus. The converter apparatus may include a converter having an input side for excitation radiation and an output surface for used light. The converter apparatus may further include a heat sink. The input side may be connected to the heat sink via at least one heat sink surface. The input side may have at least one input surface. The at least one input surface may be configured to receive excitation radiation from at least one radiation source at an angle γ with respect to a surface normal to the input surface, such that the excitation radiation from the at least one radiation source is reflected at the output surface.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the present disclosure. In the following description, various embodiments of the present disclosure are described with reference to the following drawings, in which:

FIG. 1 shows a longitudinal section of a converter apparatus in accordance with an embodiment;

FIG. 2 shows a luminance distribution of used light exiting the converter apparatus;

FIGS. 3 to 5 show a view from below and, respectively, a longitudinal section of a converter apparatus in accordance with in each case one further embodiment;

FIG. 6 shows a longitudinal section of part of a converter apparatus in accordance with a further embodiment;

FIG. 7 schematically shows a geometric configuration of a serrated output coupling surface of the converter apparatus from FIG. 6;

FIG. 8 shows a longitudinal section of a converter apparatus in accordance with a further embodiment;

FIG. 9 shows a view from below of a converter apparatus in accordance with a further embodiment; and

FIG. 10 shows a longitudinal section of a converter apparatus in accordance with a further embodiment.

### DESCRIPTION

The following detailed description refers to the accompanying drawings that show, by way of illustration, specific details and embodiments in which the various aspects of the present disclosure may be practiced.

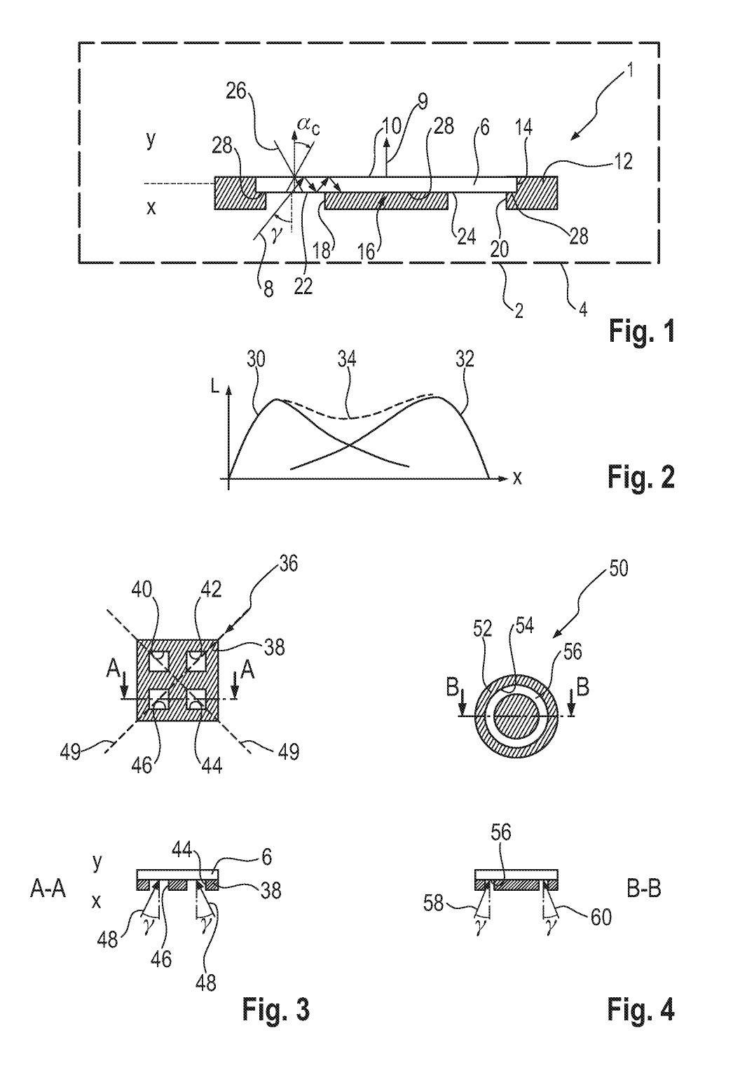

FIG. 1 illustrates a converter apparatus 1. Said converter apparatus is part of an illumination arrangement 2, which in turn is placed in a headlamp 4. Both the illumination arrangement 2 and the headlamp 4 are schematically illustrated with a dashed line in FIG. 1. The converter apparatus 1 has a converter 6. Said converter can be used to at least partly convert excitation radiation 8, for example blue laser light from a laser diode, into yellow conversion radiation. The conversion radiation together with non-converted excitation radiation (in the case of partial conversion) then forms used light 9 which is capable of being emitted via an output coupling surface 10 of the converter, with the used light 9 being schematically indicated with an arrow in FIG. 1. The converter 6, which is illustrated in FIG. 1 in a longitudinal section, can be rectangular or square or round or free-form.

The converter 6 is enclosed by a heat sink 12. Said heat sink is here arranged on the input coupling side of the converter 6 and engages around its peripheral surface 14. Consequently, the converter 6 has a heat sink 12 on the input coupling side 16 thereof that is remote from the output coupling surface 10. In accordance with FIG. 1, said heat sink has two through-holes 18 and 20. Said through-holes 18 and 20 delimit a respective input coupling surface 22 and 24 on the input coupling side 16. The excitation radiation 8 or in each case one excitation radiation can then be coupled in via the input coupling surfaces 22 and 24.

Alternatively, it is feasible to provide, in place of the two through-holes 18 and 20 and the corresponding input coupling surfaces 22 and 24, a single or a plurality of circular-annular through-holes that in that case correspondingly delimit/delimits a circular-annular input coupling surface, with the result that the used light is homogeneous or homogenized from all sides. A central axis of the through-hole(s) and the input coupling surface(s) then may extend in the direction of a surface normal of the input coupling surface 22 or in the direction of the used light 9. By way of example, a multiplicity of radiation sources in the form of laser diodes can be disposed around the through-hole(s). Here, a plurality of pairs can be provided that each have two laser diodes, whose laser diodes in turn can then in each case be situated diagonally with respect to one another. The pairs can be arranged in the shape of a star.

FIG. 1 illustrates in simplified manner only the excitation radiation 8 that is coupled into the input coupling surface 22. Said excitation radiation is here coupled in at an angle γ with respect to a surface normal at the input coupling surface 22. The angle γ is here greater than an angle α_{c}, which is a half-opening angle of an exit cone 26. The excitation radiation 8 can therefore not exit directly via the output coupling surface 10, but is reflected thereby.

The input coupling side 16 according to FIG. 1 is connected to the heat sink 12 via heat sink surfaces 28. The surfaces of the heat sink 12 that are located opposite the heat sink surfaces 28 and the peripheral surfaces 14 have a mirrored configuration.

According to FIG. 1, a first optical half space X is provided by the input coupling side 16, and a second optical half space Y is provided on sides of the output coupling surface 10.

FIG. 2 illustrates a section through a resulting luminance distribution of used light 9, which exits from the output coupling surface 10, see FIG. 1, into the half space Y. Shown on the ordinate is here the luminance L, and shown on the abscissa is a direction X transversely to the optical main axis of the converter apparatus 1 from FIG. 1. A curve 30 here shows the luminance distribution of the exiting used light 9 from FIG. 1, the generating excitation radiation 8 of which is supplied substantially via the input coupling surface 22 and which is coupled out via the output coupling surface 10. A curve 32 then shows the luminance distribution of the exiting used light 9, the generating excitation radiation of which is supplied substantially via the input coupling surface 24 and which is capable of being coupled out via the output coupling surface 10 in accordance with FIG. 1. If, for example, only the excitation radiation 8 is coupled in, the luminance distribution of the used light 9 in accordance with the curve 30 is non-symmetric and one-sided. The same is true if only excitation radiation is coupled in via the other input coupling surface 24 from FIG. 1, which can be seen from the curve 32. However, if simultaneous input coupling is effected with the same radiant power, this results in a symmetric distribution of the used light 9, which can be seen from the curve 34. The further excitation radiation may then likewise be coupled in at an angle γ via the input coupling surface 24 in FIG. 1, wherein the radiation directions can intersect and the excitation radiations are then capable of being arranged approximately in the shape of a v. It is feasible to provide for the input coupling surface(s) 22 and/or 24 a plurality of excitation radiations or in each case a plurality of circumferential excitation radiations, which are each coupled in at the angle γ. The excitation radiations can here be arranged in a circumferential fashion. The excitation radiations of an input coupling surface or of a respective input coupling surface are here located for example geometrically on a lateral surface of a frustum of a cone or of a cone or of an, in particular n-sided, frustum of a pyramid or an, e.g. n-sided, pyramid, wherein n can be the number of the corners of the input coupling surface if an angular input coupling surface is provided. The excitation radiations of an input coupling surface or of a respective input coupling surface are preferably arranged equidistantly. In other words, more than one laser diode per input coupling surface can be used. Each laser diode is coupled in at the angle γ and the circumferential angular positions or the direction vectors of the excitation radiations can differ. The excitation radiations may be arranged equidistantly in circumferential fashion.

FIG. 3 illustrates a further embodiment of a converter apparatus 36. This converter apparatus in accordance with the bottom depiction in FIG. 3 that illustrates a longitudinal section has the converter 6, wherein—in contrast to FIG. 1—a heat sink 38 does not engage around it. In accordance with the upper depiction in FIG. 3, which shows a view from below, the heat sink 38 has four through-holes 40 to 46 that are arranged in the manner of a matrix. The heat sink 38 furthermore has an approximately square cross section. The through-holes 40 to 46 are here likewise configured to be approximately square and symmetric. The bottom depiction shows a sectional view of the line A-A from the upper depiction. In accordance with the bottom depiction, a dedicated excitation radiation 48 is provided for a respective through-hole 44, 46. This also applies to the further through holes 40 and 42. As a result, four excitation radiations 48 are coupled into the converter. They are incident here on the corresponding input coupling surface again at an angle γ. Directions 49 of the excitation radiations are schematically indicated in the upper depiction in FIG. 3 by way of a dashed line. The excitation radiations for the input coupling surfaces 40 and 44 are here situated in a plane that extends through the outer corners of the input coupling surfaces 40 and 44 and is parallel to the surface normal of the input coupling surfaces, and are arranged in the shape of a v and symmetrically with respect to one another. The same applies for the excitation radiations for the input coupling surfaces 42 and 46 which are here situated in a plane that extends through the outer corners of the input coupling surfaces 42 and 46 and is parallel to the surface normal of the input coupling surfaces, and are arranged in the shape of a v and symmetrically with respect to one another. The excitation radiations therefore approach each other in a direction toward the input coupling surfaces. This superposition of the excitation radiations produces an advantageous 2D homogenization. Also feasible for the excitation radiations are here arrangements as are provided in other embodiments. In accordance with FIG. 4, the upper depiction shows a further embodiment of a converter apparatus 50 as viewed from below. It has a circular cross section. A heat sink 52 has a circular-annular through-hole 54 which then delimits a corresponding circular-annular input coupling surface 56. The bottom depiction shows a sectional view of the section line B-B from the upper depiction (longitudinal section). Here, at least two excitation radiations 58, 60 are coupled into the input coupling surface 56 at the angle γ. The excitation radiations 58 and 60 are here aligned to be approximately v-shaped with respect to one another. The arrangement of the excitation radiations 58 and 60 and possibly further excitation radiations can be provided, for example, as in the illustrations of FIG. 1 or FIG. 2.

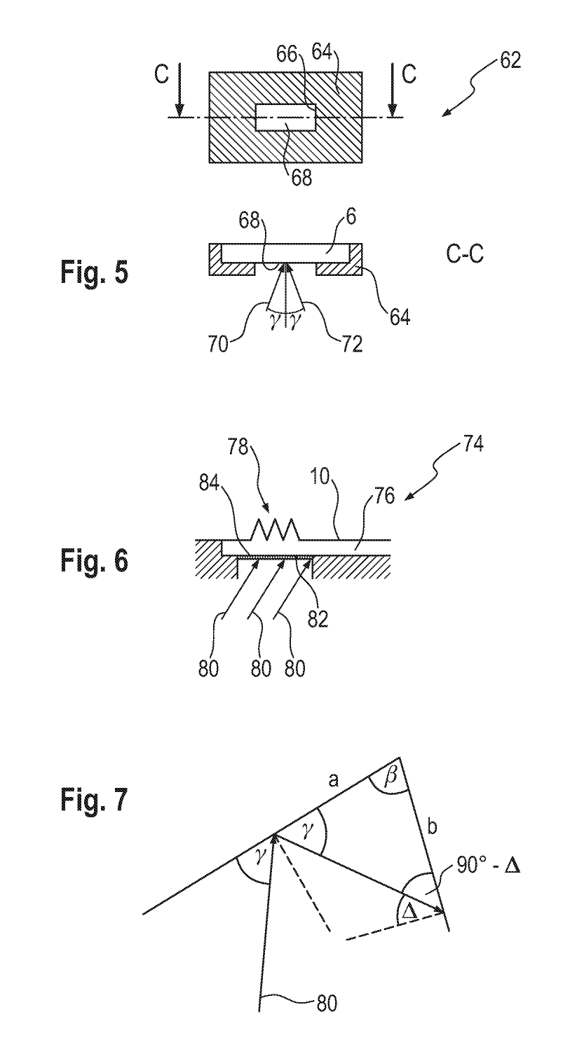

FIG. 5 shows a further embodiment of a converter apparatus 62. The upper depiction shows said converter apparatus 62 in a view from below. A heat sink 64 here has a rectangular cross section. An elongate slit-like through-hole 66 is located centrally and delimits an input coupling surface 68. The bottom depiction in accordance with FIG. 5 shows the section along the section line C-C from the upper depiction (longitudinal section). It is clear here that the heat sink 64 laterally engages around the converter 6 in a manner corresponding to FIG. 1. Excitation radiations 70 and 72 are coupled into the input coupling surface 68 at the angle γ. They are here once again aligned to be v-shaped with respect to one another.

FIG. 6 shows a further embodiment of a converter apparatus 74. A converter 76 here has on its output coupling surface 10, at least over a portion, a serrated surface structure 78. This has the effect that excitation radiation 80 is capable of being coupled in at an acute angle γ. It is feasible due to the serrated surface structure 78 to couple in the excitation radiation 80 parallel with respect to the surface normal of an input coupling surface 82 of the converter 76. In accordance with FIG. 6, the input coupling surface 82 furthermore has an anti-reflective coating 84.

FIG. 7 shows the geometric design of the serrations of the surface structure 78. The excitation radiation 80 that is coupled into the converter 76, see FIG. 6, and is not scattered and converted is here incident on an exit surface a of a serration or triangle of the surface structure 78 at the angle γ. If the angle γ is greater here than the angle α_{c} (see also FIG. 1, for example), total internal reflection (TIR) occurs, where an angle of incidence corresponds to an angle of reflection. By correspondingly defining an opening angle β of the triangular structure in FIG. 7, this condition can also be ensured for the second output coupling surface b of the serration of the surface structure 78, see FIG. 6, with the result that the excitation radiation 80 is reflected back into the volume of the converter 76. Consequently, in the triangles in accordance with FIG. 7: γ+β+90°−Δ=180°, wherein Δ=90°−γ−β. Considering that the angle γ is greater than the angle α_{c}, the excitation radiation 80 which is normally incident on the input coupling surface 82, see FIG. 6, would be entirely reflected at the surface structure 78 back into the converter 76 due to total internal reflection.

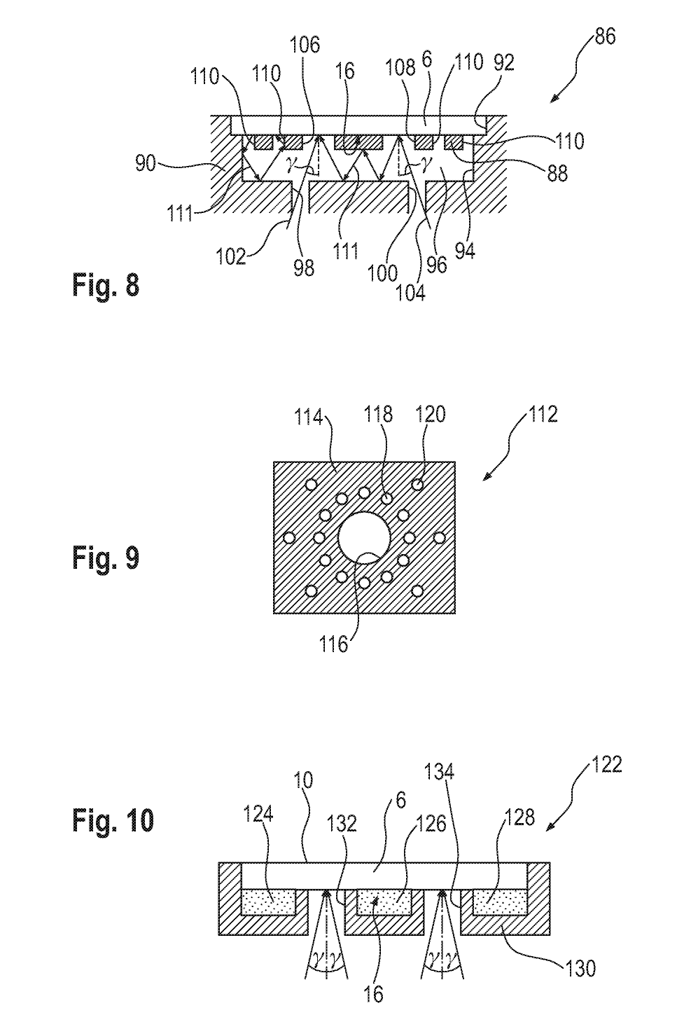

FIG. 8 shows a further embodiment of a converter apparatus 86. Here, a heat sink 88 is arranged in front of the converter 6. The converter 6 is furthermore placed inside a chamber housing 90. The chamber housing 90 has a stepped cutout having a first step 92, which is adjoined by a second step 94 having a smaller diameter. The converter 6 is here placed into the first step 92. In 94, a, e.g. cuboid, chamber 96 is then formed, which is delimited by the input coupling side 16 of the converter 6 and the chamber housing 90. The heat sink 88 is furthermore arranged in the region of 94 and thus inside the chamber 96. Chamber walls of the chamber 96 have a mirrored configuration. The chamber housing 90 furthermore has two chamber openings 98, 100, via which in each case one excitation radiation 102, 104 is coupled in. The latter are then incident on a respective input coupling surface of the converter 6 by through-holes 106, 108 of the heat sink 88. In addition to the through-holes 106 and 108, the heat sink 88 has further through-holes 110. The excitation radiations 102, 104 do not enter the converter directly via said through-holes 110, but radiation from the chamber 96 can be coupled in via them. Excitation radiation that does not enter the converter 6 due to reflection can pass into the chamber 96 and then be reflected back to the converter 6 by the latter and be “recycled” hereby. Conversion radiation, but also non-converted excitation radiation, can furthermore enter the chamber 96 from the converter 6 through the through-holes 106, 108 and 110 and here likewise be reflected back and “recycled” hereby. This may bring about homogenization of the ultimately emitted used light.

The chamber 96 in FIG. 8 may be provided in place of the anti-reflective coating from FIG. 6. It is then possible with the chamber 96, which may be delimited by highly reflective or at least low-absorbing surfaces, for radiation exiting from the input coupling side 16 to be at least partially recycled, which is shown by way of example in FIG. 8 by the radiation paths 111.

FIG. 9 illustrates a further converter apparatus 112 viewed from below. A heat sink 114 here has a central circular through-hole 116. At a radial distance therefrom, a multiplicity of further through-holes 118 are arranged around it. Arranged around the through-holes 118 in turn are likewise further through-holes 120. The excitation radiation may be coupled in via the central through-hole 116. Radiation, which is recycled for example via a chamber 96, see FIG. 8, can be coupled in via the other through-holes 118 and 120. The luminance may therefore be the greatest in the center and then reduces as the distance to the center increases. This may be provided if the converter apparatus 112 is used for a headlamp to image a light image in a far field. In other words, a major portion of an excitation radiation can be introduced centrally via the through-hole 116. A luminance on the exit side can then be concentrated centrally in a rotation-symmetric fashion, because the peripheral regions having the through-holes 118, 120 receive less excitation radiation from the chamber 96, see FIG. 8.

FIG. 10 shows a further embodiment of a converter apparatus 122. In addition to the converter 6, three converter elements 124, 126 and 128 are arranged on the input coupling side 16 of said converter. These are arranged here at a distance from one another. Furthermore, a heat sink 130 engages around the converter elements 124 to 128. The heat sink 130 furthermore has two through-holes 132 and 134 to couple in excitation radiation, which for the sake of simplicity is not provided with a reference sign. The converter elements 124 to 128 may here be configured as non-scattering single-phase ceramics. The converter 6, on the other hand, has a scattering configuration. It is possible with the converter 6 to convert coupled-in excitation radiation for example into yellow conversion radiation and scatter it. If excitation radiation enters the converter elements 124 to 128, it can be converted here for example into red conversion radiation. This can in turn be guided back to the converter 6, e.g. if the heat sink 130 has a mirrored or reflective configuration. Scattering of the red conversion radiation then may likewise take place in the converter 6. For example red and yellow conversion radiation and blue, non-converted excitation radiation can then be emitted in the form of used light, which is scattered, via the output coupling surface 10.

Disclosed is a converter apparatus having a converter on whose entry side a heat sink is arranged. Said heat sink has at least one through-hole, via which an input coupling surface on the entry side is then accessible. Excitation radiation can then enter the converter via the input coupling surface and exit from an exit surface of the converter that is remote from the entry surface.

Various embodiments provide an illumination arrangement and a headlamp that have improved heat dissipation and an improved light image.

In accordance with various embodiments, an illumination arrangement having a converter apparatus for a remote phosphor light source is provided. The converter apparatus can have a converter having an input coupling side for at least one excitation radiation and an output coupling surface for, e.g. at least one, used light. The input coupling side may be connected to at least one heat sink via at least one heat sink surface. Provision may furthermore be made for the input coupling side to have at least one input coupling surface for coupling in the excitation radiation. The at least one heat sink surface can thus advantageously differ from the at least one input coupling surface. Furthermore, at least one radiation source may be provided which can emit excitation radiation. The excitation radiation is here capable of being coupled into an input coupling surface. The excitation radiation is preferably capable of being coupled in at an angle γ with respect to a surface normal of the input coupling surface such that the excitation radiation is reflected, e.g. in the non-converted and/or non-scattered state, at the output coupling surface. This solution has the advantage that the converter apparatus combines the effects of a reflective converter and a transmissive converter. In various embodiments, the input coupling side has a double function, namely first, that of coupling in excitation radiation via the input coupling surface, which is then capable of being emitted via the output coupling surface, which means the converter is transmissive for radiation. Secondly, heat can be dissipated via the input coupling side via the heat sink surface to the heat sink. It is not necessary here for the heat sink to have a transparent design, which means it is non-transparent, for example. Consequently, the excitation radiation can enter the converter from the input-side half space thereof and exit from the output coupling surface via a further, output-side half space. At least one input-side optical unit can then be arranged in the first half space and at least one output-side optical unit can be arranged at a second half space, which each offer a large installation space. In accordance with various embodiments, only one section of the input coupling side has an optically transparent configuration toward the input-side half space, which means the excitation radiation is coupled into the converter only here. Coupling in the excitation radiation at the angle γ advantageously prevents, e.g. non-converted and non-scattered, excitation radiation from exiting from the output coupling surface. Instead, the excitation radiation is guided back into the converter. This may produce homogenized used light, which in turn produces an improved light image. In other words, additional backscatter effects are used to increase the homogeneity of the used light. For example, if blue excitation radiation or blue laser light is used, which is partly converted into yellow conversion radiation, a yellow-blue gradient in the used light is avoidable, or at least significantly reducible (both in the position space and in the angle space), due to the homogenization.

In various embodiments, at least two radiation sources are provided, via which in each case one excitation radiation is capable of being coupled into the at least one input coupling surface. The excitation radiations can here each be capable of being coupled in at the angle γ with respect to the surface normal of the input coupling surface. In various embodiments, the excitation radiations, e.g. from at least two radiation sources, are arranged so as to be v-shaped and symmetric with respect to one another or parallel with respect to one another. This type of arrangement may produce homogenized used light if a plurality of excitation radiations are provided. Likewise feasible is the provision of a combination of v-shaped and parallel excitation radiations, e.g. if more than three excitation radiations are provided.

In various embodiments, a plurality of input coupling surfaces are provided. In this case, at least one excitation radiation can be provided for a respective input coupling surface. The excitation radiations may here be arranged as explained above. In the case of a multiplicity of excitation radiations, at least two can be arranged in the shape of a v and be symmetric or parallel with respect to one another.

In various embodiments, a plurality of beam pairs can be provided which each have two excitation radiations which are arranged in the shape of a v and symmetric with respect to one another, e.g. with respect to an optical main axis of the converter. As a result, homogenized used light is capable of being formed in a simple manner in the case of a multiplicity of beam pairs. The v-shaped and symmetric arrangement of the excitation radiations of each beam pair may take place in each case in a plane which extends, e.g. approximately, parallel with respect to the surface normal or which extends, e.g. approximately, parallel with respect to the optical main axis of the converter. The symmetric arrangement of two excitation radiations is, for example, effected with respect to a surface normal of the converter.

In various embodiments, at least one beam pair or in each case at least one beam pair is/are associated with an input coupling surface or part of the input coupling surface or a respective input coupling surface. If a plurality of beam pairs are provided for the input coupling surface or for part of the input coupling surfaces or for a respective input coupling surface, it is possible for the beam pairs to be arranged symmetrically with respect to one another at the corresponding input coupling surface. By way of example, the arrangement of the beam pairs can be in the shape of a star or a cross, or the beam pairs are arranged on a pitch circle. If an approximately angular, e.g. rectangular, input coupling surface is provided, the beam pairs can be located in each case in a plane that extends parallel with respect to the surface normal of the input coupling surface and through two diagonal corners and/or be located in each case in a plane that extends parallel with respect to the surface normal of the input coupling surface and transversely to opposite lateral surfaces of the input coupling surface.

In various embodiments, at least two excitation radiations or the excitation radiations of a beam pair or of part of the beam pairs or of a respective beam pair are coupled in at a common input coupling location, which may be provided for example in the case of small input coupling surfaces. Alternatively, it is feasible to provide input coupling at different input coupling locations to couple in the excitation radiations with better distribution, which improves the homogeneity of the used light.

The excitation radiations that are arranged in the shape of a v may approach one another in a direction of the input coupling surface(s).

The at least one heat sink surface or the heat sink surfaces may be larger overall than the at least one input coupling surface or the input coupling surfaces. It is thereby possible for a major part of the input coupling side to be covered by the heat sink, which results in effective heat dissipation.

In various embodiments, the heat sink is configured to be, e.g. at least in a section-wise fashion, reflective or mirrored at least in the region of the at least one heat sink surface. In other words, the surface of the heat sink that is connected to the heat sink surface of the converter can be configured at least in a section-wise fashion or completely to be reflective and/or low absorbing. This solution may have the effect that at least part of or a major part of the radiation in the converter that radiates toward the heat sink can be reflected back thereby and thus for example become part of the used light. This can further improve the homogenization.

In various embodiments, provision may be made for the angle γ to be greater than an angle α_{c}, wherein the angle α_{c} may be a half opening angle or a half cone angle of an exit cone on the exit surface, wherein radiation, e.g. used light, is capable of being coupled out of the output coupling surface from the exit cone. A longitudinal axis of the exit cone can be, for example, parallel with respect to a surface normal of the output coupling surface. Radiation outside the exit cone may be reflected at the output coupling surface. Since the excitation radiation radiates in at an angle γ, which is greater than the angle α_{c}, it cannot exit directly from the output coupling surface because the radiation would be located outside the exit cone. As a result, the excitation radiation is reflected at the output coupling surface and guided back into the interior of the converter, e.g. by way of total internal reflection (TIR). The reflected radiation can make a contribution to the used light, and non-scattered and/or non-converted excitation radiation is prevented from exiting the converter. As a result, without scattering and/or conversion of the excitation radiation it is not possible for the latter to exit the converter. The angle α_{c} or exit angle α_{c} is a result of the refractive indices between the converter and the medium adjoining the output coupling surface. It may be provided that, due to the reflection of the excitation radiation at the output coupling surface, said radiation can be distributed better in the converter. Despite coupling in the excitation radiation via a delimited input coupling surface, which e.g. constitutes a small proportion of the total input coupling side, it is thus possible for the excitation radiation to be effectively distributed in the entire volume of the converter. Consequently, a converter apparatus is provided, the thermal performance of which is comparable to a converter that is configured in a reflective variant. It may additionally be provided that the transmissive concept of the converter apparatus results in a configuration that is simple in terms of apparatus, e.g. of the entire optical system.

The converter may be made of a phosphor. In various embodiments, the converter includes a ceramic material. In various embodiments, the converter is configured in the manner of small plates. The output coupling surface and the input coupling side can extend, for example, e.g. approximately, at a parallel distance from one another.

The angle α_{c} may be obtained from the following relationship: α_{c} equals arcsin(n₂/n₁). Here, n₂ can be a refractive index of a medium that adjoins the output coupling surface from the outside, such as air, and ni can be a refractive index of the output coupling surface of the converter. This results in a jump in the refractive indices between the converter material and the adjoining medium at a boundary layer between the converter and the adjoining medium. This then produces the exit cone that is defined by the angle α_{c}. Consequently it may be provided that coupling of the excitation output into the total converter volume, as explained above, is made possible due to said jump in refractive indices. The jump in refractive indices can thus be used and set as an optimization parameter. Setting may be effected by way of material selection. In various embodiments, the converter consists at least partly or completely or substantially completely of Gd:YAG ceramic (gadolinium:yttrium aluminum garnet ceramic), e.g. for yellow conversion radiation, for example at an excitation radiation having a wavelength of 450 nm. The refractive index ni can here be 1.85, e.g. for wavelength of the excitation radiation of 450 nm. Additionally provided as a material for the converter can be one that results in no conversion of the excitation radiation, such as aluminum oxide (Al₂O₃). This material can be introduced as a second phase for optimizing the thermal conductivity. If aluminum oxide is provided, it has a refractive index n₁ of 1.78, e.g. at a wavelength with the excitation radiation of 450 nm. It therefore may have a similar refractive index ni to the Gd:YAG ceramic. If air is provided as a medium adjoining the output coupling surface, it has a refractive index n₂ of 1. For the converter including or essentially consisting of a Gd:YAG ceramic, this can produce an angle α_{c} of approximately 38°.

The output coupling surface of the converter in a further configuration of various embodiments may be provided with a coating that has a greater refractive index ni than for example the Gd:YAG ceramic to reduce the angle α_{c} and to thereby in turn reduce the size of the exit cone. By way of example, a coating of a, e.g. highly refractive, glass can be provided. In various embodiments, a silicate glass can be provided as the coating. The latter can have a refractive index n₁ of approximately 2, which would result in an angle α_{c} of approximately 30°. It is alternatively feasible to provide as the coating a diamond coating that can have a refractive index n₁ of 2.4, which can result in an angle α_{c} of approximately 25°.

It may furthermore be possible for the exit cone to also be increased in size if necessary. This can be achieved, for example, by coating the output coupling surface of the converter with a material that has a lower refractive index n₁ than the converter material. By way of example, an, in particular low-refractive, glass can be provided herefor, such as a quartz glass, which can have a refractive index n₁ of 1.5.

The used light is coupled out of the output coupling surface e.g. by way of two mechanisms, specifically scattering and conversion. As soon as a scatter event occurs inside the converter, the scattered radiation can pass into the exit cone and thereby exit the converter. In this way it is possible for both non-converted, scattered excitation radiation and converted, scattered conversion radiation to exit via the exit cone. Scattering of the radiation can here occur at a plurality of locations, for example in the volume of the converter, wherein this is made possible due to a porosity and/or to deliberately introduced scattering bodies. Provided herefor can be, for example, as already mentioned above, a two-phase ceramic, in which one phase can be aluminum oxide (Al₂O₃). Furthermore, scattering can occur at the output coupling surface of the converter by, for example, a suitable surface structuring being formed. It is furthermore feasible for scattering at a boundary layer to the heat sink to be provided. During the conversion of the excitation radiation, e.g. longer-wave conversion radiation is isotropically emitted. The original directional information relating to the original direction of the excitation radiation can get lost hereby. Consequently, at least one specific part of the conversion radiation is always located within the exit cone and can be coupled out of the converter—e.g. provided that no additional scattering processes guide the conversion radiation away from the exit cone again. The remaining part of the conversion radiation can then pass into the exit cone by way of scattering and contribute to the used light.

In various embodiments, the input coupling side of the converter can be connected to the heat sink. The latter can then have a through-hole or a plurality of through-holes. Said through-hole or through-holes can then delimit a, or a respective, input coupling surface. It is thus possible, in a method which is simple in terms of apparatus, to couple in the excitation radiation via the at least one through-hole.

The through-holes may be not connected to one another.

If a plurality of input coupling surfaces are provided, they are each assigned at least one radiation source. It is thus possible for a respective radiation source to be provided for the respective input coupling surface.

The heat sink may extend over the entire input coupling side, as a result of which a lot of heat is able to be dissipated in a manner which is simple in terms of apparatus. One through-hole or a plurality of through-holes is/are provided here in that case.

Instead of the through-hole or a plurality of through-holes or all through-holes, the heat sink may be transparent in these regions and consequently includes one or more transparent sections. By way of example, diamond or sapphire can be provided as a material herefor.

In various embodiments, provision may be made for the heat sink to laterally engage around the converter, which makes possible a fixed mechanical connection between the converter and the heat sink. In addition, radiation in the peripheral region of the converter can be reflected by the heat sink. A peripheral surface of the converter may be connected at least in section-wise fashion to the heat sink. In this way, heat can also be dissipated directly via the periphery of the converter. If the converter-facing side of the heat sink at the section of the heat sink that engages around the converter is then configured at least in section-wise fashion to be reflective and/or low absorbing, radiation that laterally exits the converter (as already mentioned) can be guided back into the converter.

In various embodiments, the through-hole of the heat sink is configured as an elongate slit. It is furthermore feasible for the heat sink to have an approximately rectangular cross section, e.g. as viewed transversely to the surface normal of the input coupling surface.

In various embodiments, provision may be made for the through-hole of the heat sink to be annular, e.g. circular-annular, or annular at least in section-wise fashion.

It may be provided if the converter is rotatable. In that case, a longitudinal axis of the, for example annular, through-hole may be located approximately in the axis of rotation.

Provision can furthermore be made for the converter to have a, e.g. approximately, round or, e.g. approximately, circular cross section as viewed transversely to the optical main axis. This may be provided if the converter is configured to be rotatable.

In various embodiments, the through-holes of the heat sink are formed in the manner of a matrix. By way of example, four through-holes are provided. They can be distributed in two rows and two columns. Due to the matrix-type configuration, a symmetric luminance distribution is advantageously obtained on the output side, e.g. in the case of symmetric input coupling of a plurality of excitation radiations. This may result in a further homogenization of the emitted used light, as a result of which for example an otherwise existing blue-yellow gradient (blue-yellow ring) is minimized. As a result, spatial homogenization and also homogenization in the angle space are achieved on the output side.

In various embodiments, the through-holes can be symmetric with respect to a longitudinal axis of the converter or with respect to a plane of symmetry in which the longitudinal axis of the converter is located. Alternatively or additionally, provision may be made for the converter to be symmetric with respect to its longitudinal axis or for it to have a plane of symmetry in which the longitudinal axis is located. It is also feasible that the converter is of rotationally symmetric design, which may be provided in the case of a rotatable converter.

In various embodiments, the heat sink can be made of a material having high thermal conductivity so as to permit effective cooling of the converter. Since the heat sink does not have to be transmissive, a high flexibility in the material selection is made possible. By way of example, the heat sink is made in a cost-effective manner from metal and/or from a ceramic, with such materials permitting great heat dissipation. It is thus possible with the heat sink to effectively dissipate the power loss being produced, for example, during the conversion of the excitation radiation.

The heat sink may be mirrored, as already mentioned above, at least in the region of the at least one heat sink surface, e.g. in at least section-wise fashion. This makes possible reflection of the radiation that is incident on the heat sink in a manner which is simple in terms of apparatus. Alternatively or additionally, provision may be made for the heat sink to have a minimally absorbing configuration.

In various embodiments, the heat sink may be connected to the converter by way of a transparent connecting means. Consequently, radiation can be incident on the heat sink directly from the converter and be reflected, for example, by said heat sink. The transparent connecting means is, for example, a transparent adhesive or a solder connection.

One task of the converter is to convert excitation radiation, for example having a wavelength of 450 nm, into conversion radiation having a longer wavelength. It can furthermore have the task of scattering both excitation radiation and conversion radiation. The path of a photon of the excitation radiation travelling through the converter can be described by the parameters of the mean free scattering path length l_{0,scattering} and the mean free conversion path length l_{0,conversion}. In the case of an already converted photon, only the mean free scattering path length l_{1,scattering} remains. These parameters are dependent on the properties of the converter and are settable. For setting said properties, doping of the converter with conversion centers can be performed for example. Alternatively or additionally, a porosity of the converter can be set. Alternatively or additionally, it is also possible for a further material phase to be distributed in the converter, which can, for example, not only have a scattering effect, but also improves internal thermal conduction. In this case, said material can be, as already mentioned above, aluminum oxide (Al₂O₃). The converter can be configured as desired using one or more of the aforementioned parameters. As a result, it is possible to set properties such as for example a color point during partial conversion or full conversion, an angle characteristic of the emitted excitation radiation, e.g. during partial conversion, and a luminance. Alternatively or additionally, the geometric shape of the heat sink can be such that specific application requirements are met.

In various embodiments, the output coupling surface may have a surface structure such that the angle γ is greater than the angle α_{c}. In this way it is possible, if necessary, for the surface structure of the output coupling surface to be adapted so that the angle α_{c} is smaller than the angle γ. This may be done by e.g. a section of the output coupling surface, which is located opposite an input coupling surface, having a serrated surface structure at least in a section-wise fashion. A plurality of such sections may be provided here. A respective serrated section of this type is formed e.g. for a respective input coupling surface. If, on the other hand, the angle γ were smaller than the angle α_{c}, the excitation radiation that was coupled in via the input coupling surface could at least partially exit from the opposite section of the output coupling surface. This may result in a reduction of the total degree of conversion and may furthermore produce a concentration of a luminance in the region of the opposite section of the output coupling surface, since the excitation radiation is not distributed in the converter. Due to the surface structure, the angle γ can now be reduced, as a result of which the excitation radiation is able to be coupled in closer to the surface normal of the input coupling surface or even parallel with respect to the surface normal.

In various embodiments, a dichroic coating can be provided at least in section-wise fashion on the input coupling surface or on the input coupling surfaces and/or a peripheral surface of the converter. The dichroic coating may transmit the excitation radiation and reflect the conversion radiation. This may result in an improved conversion efficiency because a photometrically large proportion of the conversion radiation cannot exit via the dichroic coating, but is reflected back into the converter.

In various embodiments, it is possible as an alternative or additionally to the dichroic coating, for an anti-reflective coating to be provided at least in section-wise fashion on the input coupling surface or the input coupling surfaces and/or on a peripheral surface of the converter. It is possible in this way to reduce the input coupling losses of the excitation radiation. Also feasible is to provide part of the input coupling surface or part of the input coupling surfaces with a dichroic coating and a different part with an anti-reflective coating.

In various embodiments, a chamber housing having a chamber can be provided on the input side of the converter. Said chamber can be delimited by the input coupling side of the converter at least in section-wise fashion or substantially completely or completely. The chamber may have at least one chamber opening, via which excitation radiation is able to radiate to at least one input coupling surface, e.g. directly. At least one chamber wall or at least part of the chamber wall or all chamber walls of the chamber may be configured in an at least section-wise manner to be reflective or configured in an at least section-wise manner to be mirrored and/or low absorbing. The chamber housing may have the effect that radiation that exits the converter on the input side can at least partially be returned to the converter by reflection at the at least one chamber wall and can subsequently exit from the output coupling surface, e.g. via corresponding scatter processes inside the converter. Alternatively or in addition to the reflective configuration, it is conceivable for at least one chamber wall or for at least part of the chamber walls or for all chamber walls of the chamber to be configured at least in a section-wise manner to be scattering. In various embodiments, a scattering layer can be applied herefor at least in a section-wise manner. By way of example, a scattering coating having as low as possible an absorption, as is for example used in an integrating sphere, may be used. Diffuse light propagation due to the scattering inside the chamber would result in an additional homogenization effect. The chamber may be formed in place of an anti-reflective coating.

In various embodiments, provision may be made for the heat sink to have a pattern of through-holes via whose design a luminance is settable on the output side of the converter. In various embodiments, an input coupling surface is then accessible via the respective through-hole. This may be provided if the chamber is additionally provided. Due to the chamber it is then possible for radiation to be guided into through-holes, into which an excitation radiation is not coupled directly. By way of example, one through-hole or a plurality of through-holes can be provided into which excitation radiation is coupled directly, and furthermore a through-hole or a plurality of through-holes can be provided via which radiation is coupled in via the chamber. At the center of the heat sink, for example a first through hole is provided, wherein in that case one or more smaller through-holes are provided at a distance therefrom, e.g. radially. It is thus possible in a simple manner to change an average size of the input coupling surface, in particular in the radial direction. On the output side, this can then result in a higher luminance being present at the center, or centrally, than at the periphery, which produces an improved light distribution, for example in a far field when being used in a headlamp in a vehicle. By way of example, the smaller, e.g. round, through-holes can be arranged on a pitch circle to produce a uniform light image. Provision may furthermore be made for further through-holes to be arranged, e.g. radially, outside of and at a distance from the smaller through-holes. The number and/or size thereof can here be smaller as compared to the through-holes which are located further inside, as a result of which the luminance on the output side is further reduced radially outwardly. The further through-holes can be arranged on a second pitch circle.

In various embodiments, provision may be made for the converter to be configured inhomogeneously, e.g. transversely to the main emission direction. The inhomogeneity can here be in terms of the scattering properties, e.g. the scattering cross section, for adapting the luminance. Alternatively or additionally, it is feasible for conversion properties of the converter to be inhomogeneous, for example because a wavelength of the conversion radiation can differ and/or a degree of conversion is different. The converter can also have regions having different thicknesses, e.g. measured in the main emission direction. Due to the inhomogeneity of the converter, for example a variation in the scattering effect between the center of the converter and its periphery can thus be effected, whereby the luminance is adaptable. It is furthermore possible for a converter to be implemented hereby which, e.g. in the case of a full conversion, for example centrally emits red conversion radiation and at the periphery emits yellow conversion radiation. Provision can therefore be made for a color or wavelength of the conversion radiation in the central region of the converter to differ from a color of the conversion radiation in the peripheral region of the converter.

In various embodiments, at least one converter element can be arranged on or at the input coupling side or adjacent to the input coupling side of the converter, wherein the conversion radiation inside said converter element has a different color or wavelength than the conversion radiation in the converter. This may have the effect that for example a CRI value for white light generation, e.g. in the case of a partial conversion, can be improved. By way of example, excitation radiation can be converted in the converter element into red conversion radiation which is then mixed together with a yellow conversion radiation of the converter and a non-converted blue excitation radiation to form a white light, the CRI value of which is increased in comparison to a used light made of blue excitation radiation and yellow conversion radiation. The at least one converter element may be configured to be non-scattering or substantially non-scattering. The at least one converter element is, for example, a single-phase ceramic. The excitation radiations and the conversion radiations can be emitted in accordance with Lambert's law, for example, via the output coupling surface. The at least one converter element may be arranged between the heat sink and the converter. It is feasible for the at least one converter element to be surrounded, at least in section-wise fashion or completely, by the heat sink and to be connected to the converter by way of a connecting surface.

In various embodiments, provision may be made for the converter to be rotatable. For example a drive is provided for rotating the converter. It is feasible, for example, for the converter to be driven and/or mounted by way of its peripheral side in a manner that is simple in terms of apparatus. What is avoided hereby is that drive elements and/or bearing elements are provided in the region of a beam path. A friction bearing or an anti-friction bearing e.g. engages around a peripheral side of the converter. The rotatable configuration of the converter may have the effect that, in addition to its function of spreading heat, the heat sink can additionally output heat due to the convection cooling occurring owing to the rotational movement. In addition, the heat dissipation can be effected from the converter via the contact to the drive and/or to the bearing.

According to various embodiments, an illumination arrangement having a converter apparatus in accordance with one or more of the preceding aspects is provided. At least one radiation source can here be provided for the excitation radiation. The radiation source is, for example, a laser light source or laser source. This may be provided for a system design, because a radiation source of this type can be used to emit an extremely low diverging excitation radiation. Said excitation radiation can then be coupled in in a targeted fashion such that the angle γ is greater than the angle α_{c}. As an alternative to the laser light source, it is feasible to use a light-emitting diode (LED). The latter can be present in the form of at least one individually packaged LED or in the form of at least one LED chip having one or more light-emitting diodes. It is possible for a plurality of LED chips to be mounted on a common substrate (“sub-mount”) and to form an LED or be attached individually or together for example on a printed circuit board (e.g. FR4, metal core PCB etc.) (“CoB”=Chip on Board). The at least one LED can be equipped with at least one dedicated and/or common optical unit for beam guidance, for example with at least one Fresnel lens or a collimator. Instead of or in addition to inorganic LEDs, for example based on AlInGaN or InGaN or AlInGaP, generally also organic LEDs may be used (OLEDs, e.g. polymer OLEDs). The LED chips can be directly emitting or have an upstream phosphor. Alternatively, the light-emitting component can be a laser diode or a laser diode arrangement. Also feasible is the provision of an OLED light-emitting layer or a plurality of OLED light-emitting layers or an OLED light-emitting region. The emission wavelengths of the light-emitting components can be in the ultraviolet, visible or infrared spectral range. The light-emitting components can additionally be provided with a dedicated converter. The LED chips may emit white light in the standardized ECE white field of the automobile industry, for example realized by way of a blue emitter and a yellow/green converter.

It is furthermore alternatively feasible to provide a superluminescence diode (SLED).

If a plurality of—identical or different—radiation sources are provided, they can couple excitation radiation into the converter for example from different or identical directions.

According to various embodiments, a headlamp having an illumination arrangement in accordance with one or more of the preceding aspects is provided.

The headlamp may be used for example for a vehicle. The vehicle can be an aircraft or a watercraft or a land vehicle. The land vehicle can be a motor vehicle or a rail vehicle or a bicycle. In various embodiments, the use of the vehicle headlamp in a truck or passenger car or motorcycle may be provided.

It is alternatively feasible to use the headlamp for effective illumination, entertainment illumination, architainment illumination, general illumination, medical and therapeutic illumination or for horticulture.

### LIST OF REFERENCE SIGNS

Converter apparatus 1; 36; 50; 62; 74; 86; 112; 122

Illumination arrangement 2

Headlamp 4

Converter 6; 76

Excitation radiation 8; 48; 58; 60; 70, 72; 80; 102, 104

Used light 9

Output coupling surface 10

Heat sink 12; 38; 52; 64; 88; 114; 130

Peripheral surface 14

Input coupling side 16

Through hole 18, 20; 40-46; 54; 66; 106, 108, 110; 116, 118, 120; 132, 134

Input coupling surface 22, 24; 56; 68; 82

Exit cone 26

Heat sink surface 28

Curve 30, 32, 34

Direction 49

Surface structure 78

Anti-reflective coating 84

Chamber housing 90

Step 92, 94

Chamber 96

Chamber opening 98, 100

Radiation path 111

Converter element 124, 126, 128

While the present disclosure has been particularly shown and described with reference to specific embodiments, it should be understood by those skilled in the art that various changes in form and detail may be made therein without departing from the spirit and scope of the present disclosure as defined herein. The scope of the various aspects are thus indicated by the present disclosure and all changes which come within the meaning and range of equivalency of the present disclosure are therefore intended to be embraced.

What is claimed is:

1. An illumination arrangement, comprising:
a converter apparatus including
a converter having an input side for excitation radiation, and an output surface for used light; and
a heat sink,
wherein the input side is connected to the heat sink via at least one heat sink surface,
wherein the input side has at least one input surface,
wherein the at least one input surface is configured to receive excitation radiation from at least one radiation source, and
wherein the at least one input surface is configured to receive the excitation radiation from the at least one radiation source at an angle γ with respect to a surface normal to the at least one input surface, such that the excitation radiation from the at least one radiation source is reflected at the output surface.

2. The illumination arrangement of claim 1,
wherein the at least one radiation source includes at least two radiation sources,
wherein the at least one input surface is configured to receive a respective excitation radiation from each of the at least two radiation sources, and
wherein the at least one input surface is configured to receive the excitation radiations from the at least two radiation sources at an angle γ with respect to a surface normal to the at least one input surface, such that the excitation radiations from the at least two radiation sources are reflected at the output surface.

3. The illumination arrangement of claim 2,
wherein the main emission axes of the excitation radiations from the at least two radiation sources are arranged in the shape of a “V”, and
wherein the main emission axes of the excitation radiations from the at least two radiation sources are symmetrical with respect to one another.

4. The illumination arrangement of claim 1,
wherein the heat sink has at least one through-hole therein, which delimits an input surface of the at least one input surface, and
wherein the at least one through-hole is completely surrounded by the heat sink.

5. The illumination arrangement of claim 1,
wherein the heat sink has at least one through-hole therein, which delimits an input surface of the at least one input surface, and
wherein the at least one through-hole completely surrounds at least one section of the heat sink.

6. The illumination arrangement of claim 1,
wherein the excitation radiation from the at least one radiation source includes a plurality of beam pairs,
wherein each of the plurality of beam pairs has two excitation radiations that are arranged in the shape of a “V”, and
wherein the two excitation radiations are symmetrical with respect to one another.

7. The illumination arrangement of claim 2,
wherein at least two excitation radiations for an input surface of the at least one input surface are received at a common input location of the at least one input surface.

8. The illumination arrangement of claim 2,
wherein each of at least two excitation radiations for a respective input surface of the at least one input surface are received at a respective input location of the at least one input surface.

9. The illumination arrangement of claim 1,
wherein the heat sink is reflective at least in a region of the at least one heat sink surface.

10. The illumination arrangement of claim 1,
wherein the output surface of the converter is configured to output radiation in an exit cone,
wherein an angle α_{c} is a half-opening angle of the exit cone, and
wherein the angle γ is greater than an angle α_{c}.

11. The illumination arrangement of claim 1,
wherein the converter has, on an output side thereof, a coating with a refractive index that deviates from a refractive index of a material of the converter.

12. The illumination arrangement of claim 1,
wherein the heat sink laterally engages around the converter.

13. The illumination arrangement of claim 1,
wherein the heat sink is connected to the converter by a transparent connecting structure.

14. The illumination arrangement of claim 1,
wherein, on the input side of the converter, a chamber housing having a chamber is provided that is delimited by the input side of the converter,
wherein the chamber has at least one chamber opening configured to provide the excitation radiation from the at least one radiation source to the at least one input surface, and
wherein at least one chamber wall of the chamber is at least one of reflective, low-absorbing, or scattering, at least, in a section-wise manner.

15. The illumination arrangement of claim 1,
wherein the heat sink has a pattern of through-holes therein, and
wherein a luminance on an output side of the converter is based on the pattern of through-holes in the heat sink.

16. The illumination arrangement of claim 12,
wherein the heat sink has a first through-hole at the center in the heat sink,
wherein the heat sink has one or more through-holes therein at a distance from the center of the heat sink, and
wherein each of the one or more through-holes are smaller than the first through-hole.

17. A headlamp comprising an illumination arrangement, the illumination arrangement including:
a converter apparatus, containing
a converter having an input side for excitation radiation, and an output coupling surface for used light; and
a heat sink,
wherein the input side is connected to the heat sink via at least one heat sink surface,
wherein the input side has at least one input surface,
wherein the at least one input surface is configured to receive excitation radiation from at least one radiation source, and
wherein the at least one input surface is configured to receive the excitation radiation from the at least one radiation source at an angle γ with respect to a surface normal to the at least one input surface, such that excitation radiation from the at least one radiation source is reflected at the output surface.
